(19) United States
(12) Patent Application Publication
(10) Pub. No.: US 2026/0147472 A1
(43) Pub. Date: May 28, 2026

(54) ELECTRONIC DEVICE AND METHOD FOR CORRECTING HANDWRITING INPUT DATA

(71) Applicant: SAMSUNG ELECTRONICS CO., LTD., Suwon-si (KR)

(72) Inventors: Jeongwan PARK, Suwon-si (KR); Taewon KWAK, Suwon-si (KR); Jihoon KIM, Suwon-si (KR); Donghyuk LEE, Suwon-si (KR); Heungkyo SEO, Suwon-si (KR); Heewoon KIM, Suwon-si (KR); Sunghwan PARK, Suwon-si (KR)

(21) Appl. No.: 19/453,870

(22) Filed: Jan. 20, 2026

Related U.S. Application Data
(63) Continuation of application No. PCT/KR2024/008890, filed on Jun. 26, 2024.

(30) Foreign Application Priority Data
Jul. 20, 2023 (KR) 10-2023-0094460
Aug. 11, 2023 (KR) 10-2023-0105709

(51) Int. Cl. G06F 3/04883; G06F 3/041

(52) U.S. Cl. CPC G06F 3/04883; G06F 3/04186

(57) ABSTRACT

An electronic device that receives a user input comprising a touch trajectory from a touchscreen display and can recognize handwriting input data on a per-phoneme character basis based on the user input. The electronic device according to an embodiment can distinguish between a first stroke and one or more Nₜₕ strokes constituting a phoneme character for each phoneme character corresponding to the recognized handwriting input data. The electronic device according to an embodiment can determine whether point intersections exist between the first stroke and the one or more Nₜₕ strokes for each phoneme character and, when present, determine locations. The electronic device according to an embodiment can correct each phoneme character, using the locations of the determined point intersections as a reference. The electronic device according to an embodiment can update a touch trajectory corresponding to the handwriting input data, based on the corrected phoneme characters.

### CROSS-REFERENCE TO RELATED APPLICATIONS

This application is a continuation application, claiming priority under § 365(c), of International Application No. PCT/KR 2024/008890 filed on Jun. 26, 2024, which is based on and claims the benefit of Korean patent application number 10-2023-0105709 filed on Aug. 11, 2023, in the Korean Intellectual Property Office and of Korean patent application number 10-2023-0094460 filed on Jul. 20, 2023, in the Korean Intellectual Property Office, the disclosures of which are incorporated by reference herein in their entireties.

### BACKGROUND

The disclosure relates to electronic devices and methods for correcting handwriting input data.

Electronic devices may provide handwriting input on a touchscreen display. Such devices may recognize a handwriting input (e.g., handwritten or cursive input) from a touch trajectory (or contact) on the touchscreen display and may use the recognized handwriting input data for various functions of the device (e.g., memo writing, transmission of handwritten messages).

However, handwriting drawn by a user on the touchscreen display may include errors due to characteristics of the touchscreen display surface and/or the user's handwriting characteristics. Accordingly, techniques for correction or beautification of handwriting input data on touchscreen displays have been developed.

Existing correction methods for handwriting input data include applying a system-determined pen or brush style for correction or applying a commercial font to the user's handwriting input in a batch process. However, such methods may not properly reflect the user's unique handwriting characteristics, potentially resulting in loss of those characteristics or corrections that do not match the user's handwriting style.

### SUMMARY

Various embodiments provide techniques for producing a more neatly organized handwriting style while maintaining the user's handwriting characteristics.

The subject matter described herein is not limited to the foregoing and may be implemented in various forms without departing from the scope of the disclosure.

In an embodiment, an electronic device includes a touchscreen display, a memory storing executable instructions, and a processor configured to execute the instructions. When executed by the processor, the instructions cause the electronic device to receive a user input including a touch trajectory from the touchscreen display; recognize handwriting input data in units of individual phoneme characters based on the user input; for each phoneme character corresponding to the recognized handwriting input data, distinguish a first stroke and one or more Nth strokes constituting the phoneme character; determine whether point intersection points exist between the first stroke and the one or more Nₜₕ strokes, and when present, determine locations thereof for each phoneme character; correct each phoneme character based on the locations of the determined point intersections; and update a touch trajectory corresponding to the handwriting input data based on the corrected phoneme character.

In an embodiment, a method for correcting handwriting input data performed by an electronic device includes receiving a user input including a touch trajectory from a touchscreen display; recognizing handwriting input data on a per-phoneme-character basis based on the user input; for each phoneme character corresponding to the recognized handwriting input data, distinguishing between a first stroke and one or more Nth strokes constituting the phoneme character; determining whether point intersections exist between the first stroke and the one or more Nₜₕ strokes and, when present, determining locations thereof for each phoneme character; correcting each phoneme character based on the locations of the determined point intersections; and updating a touch trajectory corresponding to the handwriting input data based on the corrected phoneme character.

In an embodiment, a non-transitory computer-readable medium stores instructions that, when executed by one or more processors, cause performance of a method for correcting handwriting input data as described herein.

According to various embodiments, an electronic device, a method, and a recording medium may recognize handwriting input data as individual phoneme character (or single-letter) units and correct the user's handwriting for each phoneme character by considering relationship characteristics between one or more strokes that constitute the phoneme character, including intersection relationships between strokes.

According to various embodiments, an electronic device, a method, and a recording medium may transform the user's handwriting input into a more neatly organized handwriting than the original while maintaining the user's handwriting characteristics, thereby avoiding user discomfort regarding changes in handwriting.

Other advantages and features of the embodiments will be set forth in the description that follows and, in part, will be apparent from the description or may be learned by practice of the embodiments.

### BRIEF DESCRIPTION OF THE DRAWINGS

FIG. 1 is a block diagram of an electronic device in a network environment according to an embodiment.

FIG. 2 is a schematic block diagram of an electronic device supporting a writing input correction function according to an embodiment.

FIG. 3 illustrates a method for correcting handwriting input data of an electronic device according to an embodiment.

FIG. 4 illustrates an example of recognition for each phoneme unit according to an embodiment.

FIGS. 5A to 5D illustrate examples of a reference feature of a recognition code for each phoneme unit of a language according to an embodiment.

FIG. 6 illustrates a method for correcting handwriting input data of an electronic device according to an embodiment.

FIGS. 7A and 7B illustrate examples of a correction screen in which a part of a stroke for handwriting input is excluded according to an embodiment.

FIGS. 8 and 9 illustrate screens showing a difference before and after correction of handwriting input according to an embodiment.

FIG. 10 illustrates a method for correcting handwriting input data of an electronic device according to an embodiment.

### DETAILED DESCRIPTION

The electronic device according to the embodiments disclosed in the disclosure may be various types of devices. The electronic device may include, for example, a portable communication device (e.g., a smartphone), a computer device, a portable multimedia device, a portable medical device, a camera, a wearable device, or a home appliance. The electronic device according to an embodiment of the disclosure is not limited to the above-described devices.

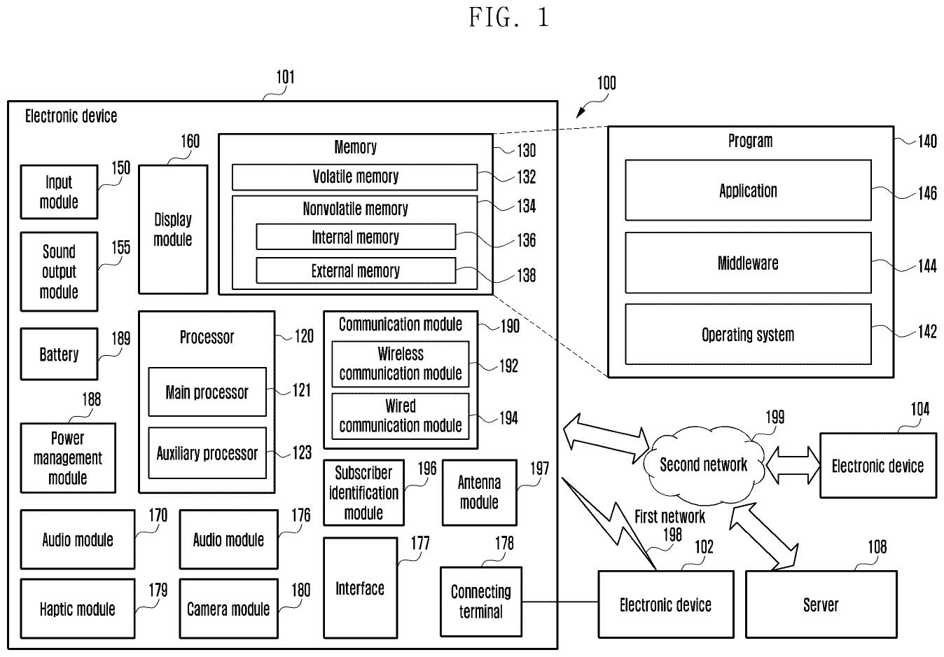

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

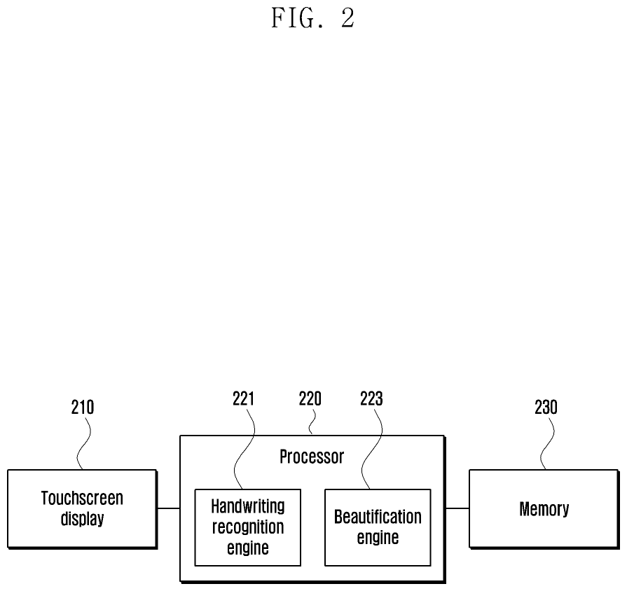

FIG. 2 illustrates a schematic block diagram of an electronic device supporting a handwriting input correction function according to an embodiment. Referring to FIG. 2, an electronic device supporting a handwriting input correction function according to an embodiment may include a touchscreen display 210 (e.g., the display module 160 in FIG. 1), a processor 220 (e.g., the processor 120 in FIG. 1), and a memory 230 (e.g., the memory 130 in FIG. 1). The electronic device 101 illustrated in FIG. 2 may further include at least some of the configurations and/or functions of the electronic device 101 in FIG. 1.

The touchscreen display 210 may display various images under the control of the processor 220. For example, the touchscreen display 210 may be implemented as any of a liquid crystal display (LCD), a light-emitting diode (LED) display, a micro-LED display, a quantum dot (QD) display, or an organic light-emitting diode (OLED) display.

The touchscreen display 210 may detect touch and/or proximity touch (hovering) inputs using a part of the user's body (e.g., a finger) or an input device (e.g., an electronic pen). For example, the touchscreen display 210 may include one or more touch sensors. The touch sensor may include any of a conductivity sensor, a capacitive touch sensor, a resistive touch sensor, a surface touch sensor, a projected capacitive (PCAP) touch sensor, or a surface acoustic wave touch sensor. The touchscreen display 210 may include at least some of the configurations and/or functions of the display module 160 and the input module 150 in FIG. 1.

The memory 230 may store instructions executable by the processor 220. The instructions may include control commands such as arithmetic and logical operations, data transfer, and input/output recognizable by the processor 220. The memory 230 may include at least some of the configurations and/or functions of the memory 130 in FIG. 1.

The processor 220 may be operatively, functionally, and/or electrically connected to each component of the electronic device 101 (e.g., the touchscreen display 210 and the memory 230), and may be configured to perform operations or data processing for controlling and/or communicating with the components. The processor 220 may include at least some of the configurations and/or functions of the processor 120 in FIG. 1.

According to an embodiment, the processor 220 may include a handwriting recognition engine 221 and a beautification engine 223. The processor 220 may perform handwriting recognition for the user input through the handwriting recognition engine 221, and may correct the recognized handwriting input (e.g., cursive input and touch-drawing input) through the beautification engine 223.

For example, the input data of the handwriting recognition engine 221 may be touch data, and the output data of the handwriting recognition engine 221 may be handwriting input data (e.g., including a recognition code and stroke data). The handwriting input data, which is the recognition result of the handwriting recognition engine 221, may be transferred as input data to the beautification engine 223, and the output data of the beautification engine 223 may be updated handwriting input data (updated stroke data).

According to an embodiment, the processor 220 may transfer result data (e.g., updated stroke data) output from the beautification engine 223 to the touchscreen display 210 and control the touchscreen display 210 to output corrected handwriting input.

The operations and data processing functions that the processor 220 may implement on the electronic device 101 are not limited, and the following describes operations for correcting the user's handwriting input (e.g., cursive input, touch-drawing input) on a per-phoneme-character basis. Operations of the processor 220 that are described below may be performed by loading instructions stored in the memory 230. The electronic device 101 according to an embodiment may include the touchscreen display 210, the memory 230 configured to store executable instructions, and the processor 220 configured to access the memory 230 to execute the instructions.

The processor 220 according to an embodiment may receive a user input including a touch trajectory from the touchscreen display 210. The processor 220 according to an embodiment may recognize handwriting input data on a per-phoneme-character basis, based on the user input. The processor 220 according to an embodiment may distinguish between a first stroke and one or more Nₜₕ strokes that constitute a phoneme character for each phoneme character included in the recognized handwriting input data. The processor 220 according to an embodiment may determine whether a point intersection exists between the first stroke and the one or more Nₜₕ strokes for each phoneme character and, when present, determine a location of the point intersection.

The processor 220 according to an embodiment may perform correction for each phoneme character according to the location of the determined point intersection. The processor 220 according to an embodiment may update the touch trajectory corresponding to the handwriting input data, based on the corrected phoneme character.

The touch trajectory according to an embodiment may include coordinate data of consecutive touch points.

The processor 220 according to an embodiment may perform an operation of recognizing the handwriting input data on a per-phoneme-character basis based on the user input and may output a recognition code and stroke data for each phoneme character as a result of the recognition. The stroke data according to an embodiment may include at least one of a recognition code for identifying a phoneme character, the number of strokes, the order of strokes, stroke point index information, stroke thickness, stroke location, stroke length, stroke slope, stroke direction, and a distance between strokes.

The processor 220 according to an embodiment, when distinguishing between a first stroke and the one or more Nₜₕ strokes constituting the phoneme character for each phoneme character, may be further configured to identify a recognition code for each phoneme character included in the handwriting input data, extract a stroke feature constituting an individual phoneme character, compare a reference feature defined in the recognition code corresponding to each phoneme character with the stroke feature of the recognized phoneme character to select a phoneme character to be corrected from among the handwriting-recognized user inputs, and distinguish between the first stroke and the Nₜₕ strokes for the selected phoneme character.

The processor 220 according to an embodiment, when extracting a stroke feature constituting an individual phoneme character, may be configured to extract angular components of the points included in each stroke, convert the extracted angular components into direction vectors, convert the angular components of the points into eight-direction vectors, and convert the eight-direction vectors into stroke scores to distinguish each stroke type.

The stroke type according to an embodiment may include one of the horizontal stroke type, vertical stroke type, or other stroke types.

The processor 220 according to an embodiment, when correcting each phoneme character based on the locations of the determined point intersections, may be configured to determine whether the touch trajectories of the first stroke and the Nₜₕ stroke constituting the phoneme character intersect each other, remove portions of the touch trajectory that extend beyond the point intersection based on the points of the first stroke and the Nₜₕ stroke when there is a point intersection, and increase the touch trajectory of either the first stroke or the Nₜₕ stroke so that a point intersection occurs when there is no point intersection.

The processor 220 according to an embodiment, when increasing the touch trajectory of the first stroke or the Nₜₕ stroke so that a point intersection occurs among the touch points when there is no point intersection, may generate a point intersection between two strokes when there is no point intersection where the trajectories intersect between the points corresponding to the touch trajectories of the first stroke and the Nₜₕ stroke, and increase the touch trajectory so that the first stroke or the Nₜₕ stroke is connected to the generated point intersection.

The processor 220 according to an embodiment, when correcting each phoneme character based on the location of the determined point intersection, may be configured to check a point intersection between the start and end points of one stroke when the phoneme character is recognized as a phoneme character composed of one stroke, remove the points of the overstretched trajectory when the point intersection between the start and end points is overstretched, and increase the touch trajectory so that a point intersection occurs when the start and end points do not intersect.

The processor 220 according to an embodiment may be configured not to perform correction for the recognized phoneme character when the stroke feature of the phoneme character recognized based on the user input does not meet the reference feature defined in the recognition code of the corresponding phoneme character.

The processor 220 according to an embodiment, when determining whether the touch trajectories of the first stroke and the Nₜₕ stroke constituting the phoneme character intersect each other, may be configured to use a counterclockwise (CCW) algorithm, to check whether there is a point intersection between points of the first stroke and the Nₜₕ stroke, or to check whether some of the points included in the trajectory of the first stroke are included in some of the points included in the trajectory of the Nₜₕ stroke.

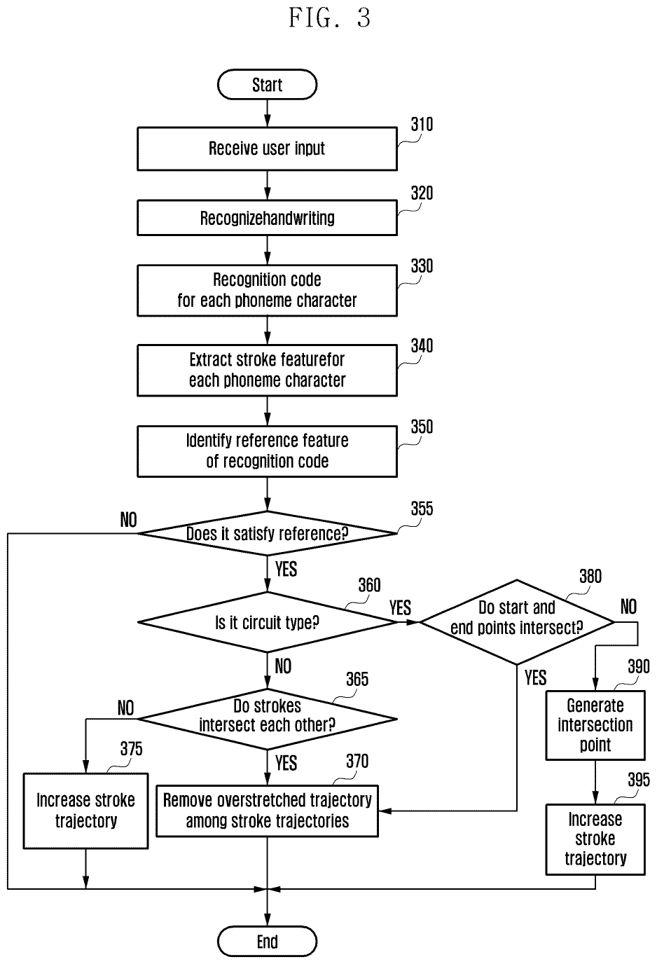

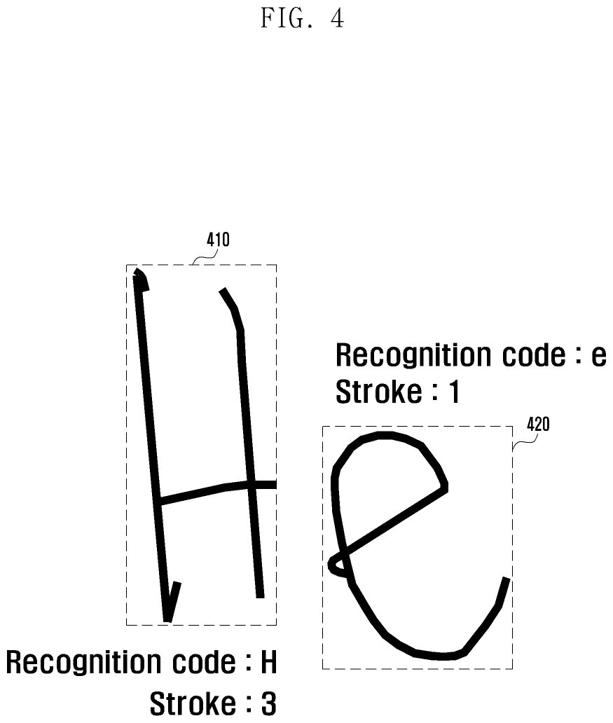

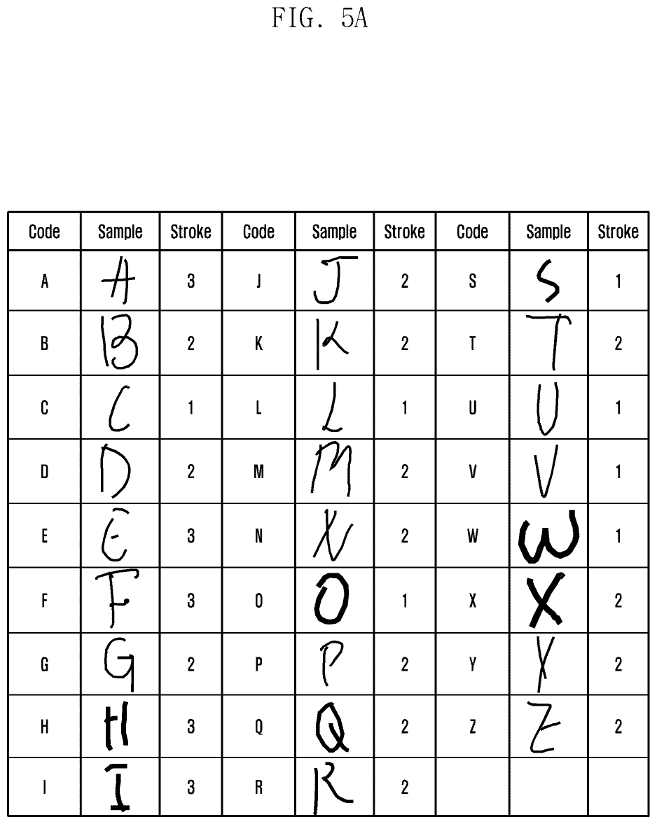

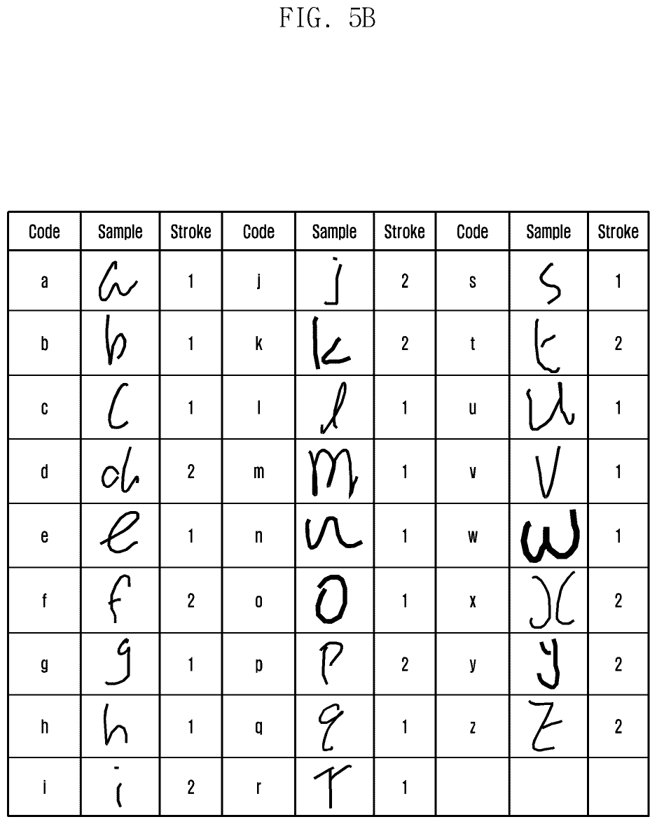

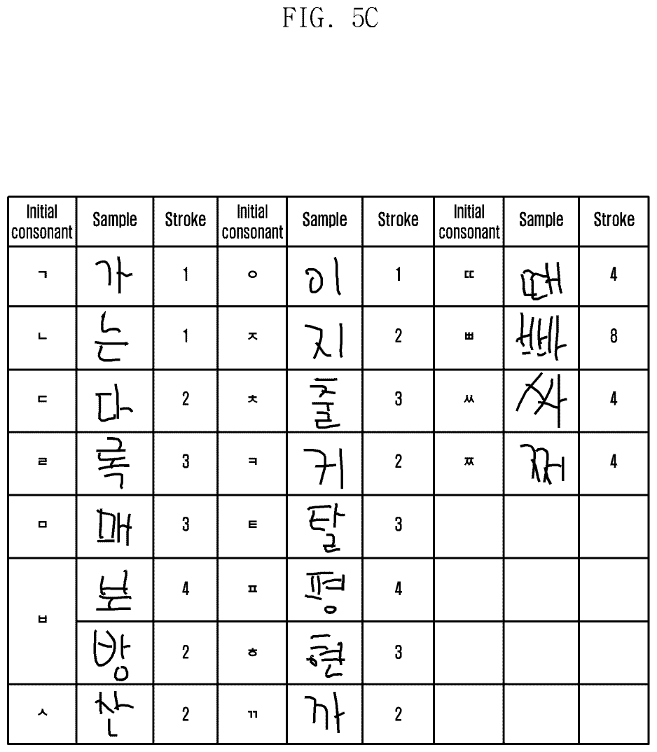

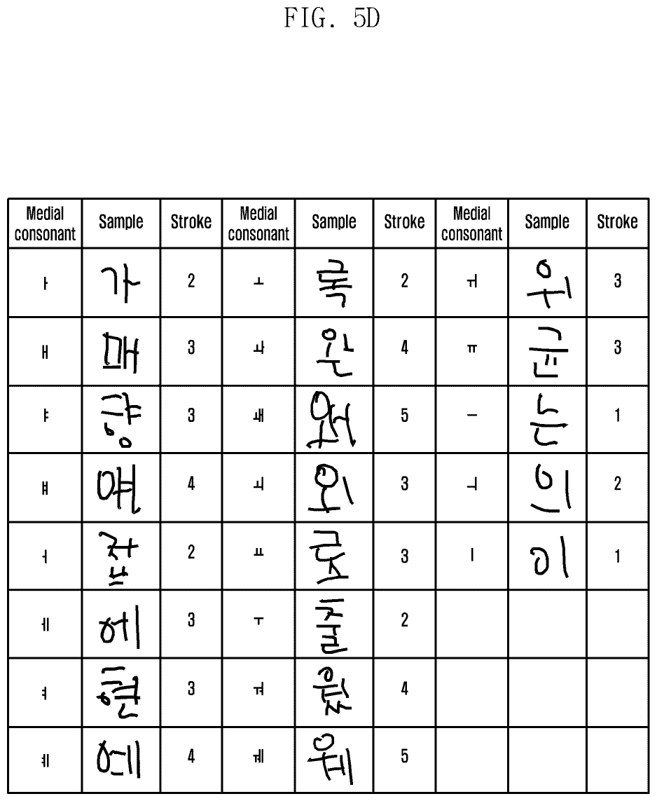

FIG. 3 illustrates a method for correcting handwriting input data of an electronic device according to an embodiment, and FIG. 4 illustrates an example of recognition for each phoneme unit according to an embodiment. FIGS. 5A to 5D illustrate examples of a reference feature of a recognition code for each phoneme unit of a language according to an embodiment.

Referring to FIG. 3, in operation 310, the processor (e.g., the processor 120 in FIG. 1 or the processor 220 in FIG. 2) of the electronic device 101 according to an embodiment receives a user input (e.g., touch data) including a touch trajectory. The processor 220 may receive the user input (e.g., touch data including a touch trajectory) based on a proximity and/or touch signal from the touchscreen display 210. For example, the electronic device may receive the user input through an application (e.g., a memo app or a note app) capable of handwriting input or a region (e.g., a touch-drawing region) capable of handwriting input. The user input may include a touch trajectory (touch coordinates).

In operation 320, the processor 220 may recognize a handwriting input (e.g., cursive input, touch-drawing input, pen input) based on the user input. For example, the processor 220 may analyze the touch data transferred from the touchscreen display 210 through a handwriting recognition engine (e.g., the handwriting recognition engine 221 in FIG. 2) to perform handwriting recognition. Handwriting input refers to data in which characters are recognized from the user's touch trajectory.

According to an embodiment, the processor 220 may recognize handwriting input by dividing it into units of individual phoneme characters (single letters) through the handwriting recognition engine 221. A phoneme character or single-letter unit means the smallest sound unit that distinguishes the meaning of a word in the phonetic system of a language. For example, English distinguishes each alphabet in units of phoneme characters, and Korean distinguishes consonants “□”, “□”, and “□” and vowels “□” and “□” in units of phoneme characters. In the case of Korean, phoneme characters may also be distinguished into initial/medial/final consonants depending on position.

For example, the handwriting recognition engine 221 may group strokes according to a touch trajectory included in the user input (e.g., touch data) in units of phoneme characters (single letters) and recognize (select) a phoneme character composed of the grouped strokes. For instance, the handwriting recognition engine 221 may group a first stroke (e.g., a vertical stroke) and a second stroke (e.g., a horizontal stroke) when the strokes constitute one character (e.g., the capital letter T), and recognize the grouped strokes as one phoneme character (e.g., the capital letter T).

The handwriting recognition engine 221 may output stroke data (handwriting input data, cursive data, touch-drawing data, or pen-drawing data) of the recognized phoneme character (e.g., English, numbers, Korean, symbols) as handwriting input data, which is the recognition result. The stroke data may include a recognition code (e.g., T) for identifying a phoneme character and stroke information (e.g., stroke information constituting the phoneme character “T”). The stroke information may include at least one of the number of strokes grouped by one phoneme character, the order of strokes, points of the strokes (e.g., index information of points included in the first stroke and index information of points included in the second stroke), stroke width or touch pressure (e.g., stroke thickness or size of a touch region), location of the stroke, length of the stroke, slope of the stroke, direction of the stroke, and distance between strokes.

According to an embodiment, the handwriting recognition engine 221 may learn and recognize the user's handwriting input through deep learning or machine learning.

The processor 220 may transfer the recognized handwriting input data (e.g., recognition code and stroke data) recognized in units of phoneme characters to the beautification engine 223 through the handwriting recognition engine 221.

For example, as illustrated in FIG. 4, the user may input “He” by handwriting on the touchscreen display 210. The processor 220 may distinguish three strokes constituting the letter “H” and one stroke constituting the letter “e” through phoneme-character-based handwriting recognition and recognize the capital letter “H” 410 and the small letter “e” 420. The capital letter “H” 410 is represented by a recognition code H (e.g., a digital code) and includes three strokes, and the small letter “e” 420 is represented by a recognition code e (e.g., a digital code) and includes one stroke.

The processor 220 may transfer the handwriting input result recognized through the handwriting recognition engine 221 to the beautification engine 223 as recognition code and stroke data for each phoneme character unit.

The processor 220 may correct the user's handwriting input in units of phoneme characters by analyzing features of the handwriting input through the beautification engine 223, as shown in operations 330 to 395.

In operation 330, the processor 220 may identify a recognition code for each phoneme character included in the handwriting input, and in operation 340, the processor 220 may extract a stroke feature that constitutes an individual phoneme character.

The processor 220 may extract angular components of consecutive points of each grouped stroke constituting a phoneme character through the beautification engine, convert the angular components of the points into eight-direction vectors, and convert the eight-direction vectors into stroke scores to distinguish stroke types. The processor 220 may identify the structure and shape of a phoneme character based on the types of grouped strokes. For example, a stroke may be implemented as a horizontal stroke, a vertical stroke, or other stroke types.

The operation of extracting stroke features may be implemented using known technologies, and thus a detailed description is omitted; other technologies for extracting stroke features may also be applied.

In operation 350, in parallel, individually, or independently of operation 340, the processor 220 may identify a reference feature (reference specification) defined in each recognition code for each recognized phoneme character. According to an embodiment, operation 350 may be performed after operation 330. The electronic device 101 may store reference feature information (e.g., a database) of the recognition code for each phoneme character, or may obtain the reference feature information of the recognition code for each phoneme character of the language corresponding to the user input from another electronic device (e.g., a server). For example, FIGS. 5A to 5D illustrate reference features of recognition codes for phoneme units, where FIG. 5A shows reference features of English capital letters, FIG. 5B shows reference features of English small letters, FIG. 5C shows reference features of Korean initial/final consonants, and FIG. 5D illustrates reference features of Korean medial vowels. Other types of phoneme units may be applied according to a language system.

In operation 355, the processor 220 may determine whether the stroke feature of the phoneme meets the reference feature of the corresponding recognition code.

For example, for the capital letter “M,” the recognition code is M (a digital code), and the reference number of strokes is two. If the user's handwriting input is recognized as the phoneme character “M,” but the number of strokes constituting the recognized phoneme character “M” is extracted as three, the processor 220 may determine that the “M” handwritten by the user does not meet the reference features defined for recognition code M.

If the recognized phoneme character's stroke feature meets the reference feature of the corresponding recognition code, the processor 220 may select the recognized character as a correction target character and proceed to operation 365; if it does not meet the reference feature, the recognized phoneme character may be excluded from the correction target and the process of FIG. 3 may be terminated.

In operation 360, the processor 220 may determine whether the phoneme character selected as a beautification target character is a circle-type phoneme character (e.g., the consonant “□” or “□,” the capital letter “O” or “Q,” or the small letter “e” or “o”).

In operation 365, when the phoneme character is not a circle-type phoneme character, the processor 220 may determine whether the trajectories between strokes constituting the phoneme character intersect. To determine whether trajectories between strokes intersect, the processor 220 may use a counterclockwise (CCW) algorithm, determine whether a portion of an extension of points included in the trajectory of a first stroke is included in a portion of the trajectory of a second stroke, or determine whether a point intersection exists between points constituting the first and second strokes.

In operation 370, when strokes have intersecting trajectories in a phoneme character that is not circle-type, the processor 220 may perform correction by removing an overstretched trajectory from among the touch trajectories. In operation 375, when strokes do not have intersecting trajectories in a phoneme character that is not circle-type, the processor 220 may perform correction by increasing the trajectory so that one stroke is connected to another stroke.

In operation 380, when a phoneme character selected as the correction target is circle-type, the processor 220 may determine whether the start and end points of the stroke intersect. In operation 390, when the start and end points of the stroke do not intersect, the processor 220 may generate a point of intersection at which the start point and the end point intersect. In operation 395, the processor 220 may increase and correct the touch trajectory so that the trajectory is connected to the point intersection. When the start point and the end point of a circle-type stroke intersect, the processor 220 may proceed to operation 370 to remove the touch trajectory in which the point intersection is overstretched and correct the same.

According to an embodiment, the processor 220 may update the handwriting input data (e.g., stroke data), such as by updating the touch trajectory, based on the correction result for each phoneme character and output the updated handwriting input on the touchscreen display.

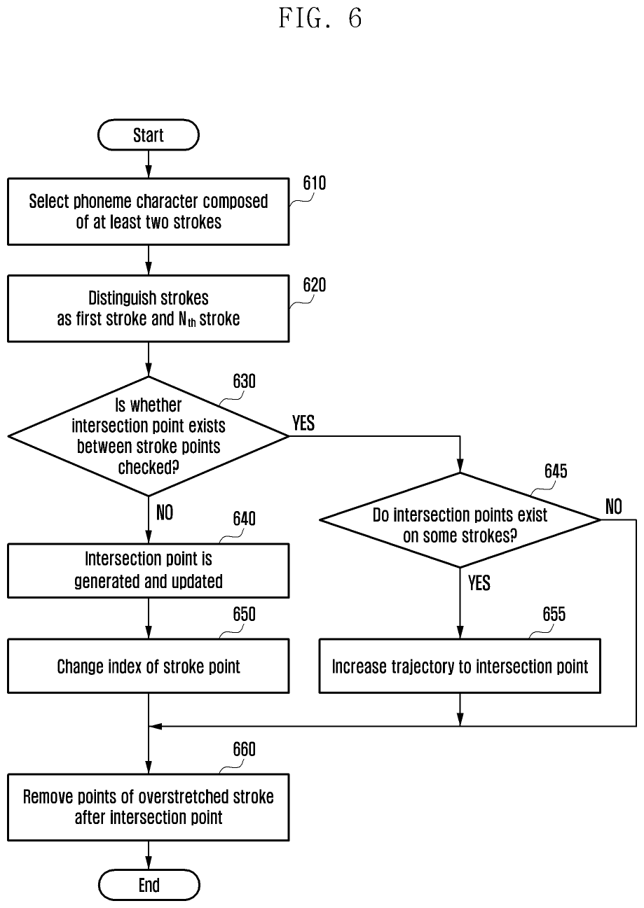

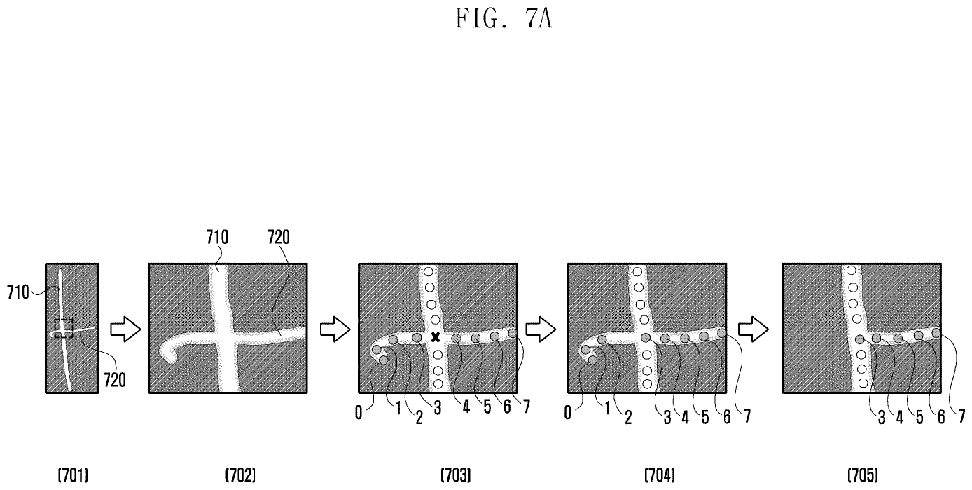

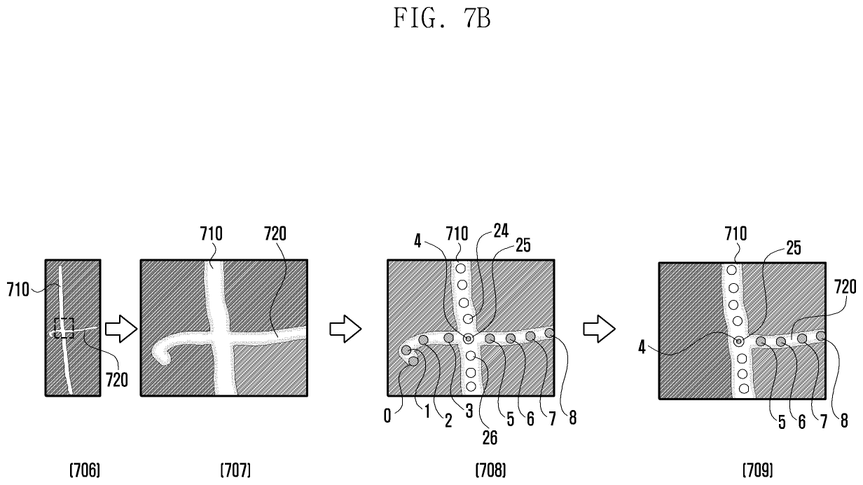

FIG. 6 illustrates a method for correcting handwriting input data of an electronic device according to an embodiment. FIG. 6 more specifically describes operations 365, 370, and 375 of FIG. 3. FIGS. 7A and 7B illustrate example screens for correcting a stroke for a handwriting input according to an embodiment.

Referring to FIG. 6, in operation 610, the processor (e.g., the processor 120 in FIG. 1 and the processor 220 in FIG. 2) of the electronic device 101 according to an embodiment may select a phoneme character composed of at least two strokes as a target character for correction as part of a correction operation. For example, the processor 220 may select a phoneme character including at least two strokes as a target character to be corrected by performing operations 355 and 360 in FIG. 3.

In operation 620, the processor 220 may distinguish strokes grouped by phoneme characters into a first stroke and an Nₜₕ stroke, and in operation 630 (corresponding to operation 370 in FIG. 3), the processor 220 may determine whether a point intersection exists between points of the strokes.

For example, when trajectories between strokes intersect each other, the processor 220 may remove an overstretched trajectory from among the touch trajectories as a correction operation for each phoneme character, and when trajectories between strokes do not intersect each other in the phoneme character, the processor 220 may increase the touch trajectory so that one stroke is connected to another stroke.

In operation 640, when the strokes do not have intersecting trajectories, the processor 220 may update a stroke point so that a point intersection is generated, and in operation 650, the processor 220 may change the index of the stroke point to the updated point intersection.

According to an embodiment, the processor 220 may store a handwriting recognition result as index information for each stroke point that constitutes a recognized character (e.g., a phoneme character) for handwriting input. The processor 220 may generate index information of points constituting a stroke and store the same. Index information of points constituting a stroke may be assigned in the order of the touch trajectory corresponding to the stroke, and one index group may be mapped to one stroke.

When the electronic device 101 displays the handwriting input, each stroke point may be represented by a trajectory extending in a direction.

For example, as illustrated in FIGS. 7A and 7B, a region in which the trajectory of a first stroke 710 and the trajectory of a second stroke 720 constituting a phoneme character intersect will be described in more detail. As shown in 701, when the point at which the first stroke 710 and the second stroke 720 intersect is enlarged, the trajectory of 702 may be drawn. The processor 220 may render a trajectory of the stroke on the display based on index information of points included in the stroke. For example, as shown in 703, the second stroke 720 may be composed of an index order of 0, 1, 2, 3, 4, 5, 6, and 7, and thus may be expressed as a trajectory from the location of the 0ₜₕ index point to the location of the 7ₜₕ index point. In the example of FIG. 7A, as shown in 703, it may be identified that there is no point intersection where the trajectories of the first stroke 710 and the second stroke 720 intersect each other.

In this case, when the electronic device displays the handwriting input, it is expressed as a trajectory extending each stroke point. If index points 0 to 3 are deleted during the correction process of the second stroke 720, the trajectory of the second stroke starts from index point 4 (i.e., the second stroke 720 is displayed in a disconnected form without being connected to the first stroke 710). ), which may be unsightly.

According to an embodiment, in the example of FIG. 7A, the processor 220 may generate (or update) a point intersection at a location where the first stroke 710 and the second stroke 720 intersect as shown in 704, and update and store the third index point of the second stroke 720 as the location of the point intersection of the first stroke 710 and the second stroke 720. For example, by updating the coordinate information of the third index point of the second stroke 720 to the coordinate information of the location where the first stroke 710 and the second stroke 720 intersect, the first stroke 710 and the second stroke 720 may include a point intersection (e.g., the third index point) with each other.

In operation 660, the processor 220 may remove points of the overstretched stroke after the updated point intersection. For example, as illustrated in FIG. 7A, the processor 220 may correct the second stroke 720 such that the second stroke 720 is connected to the first stroke 710 from the third index point, which is the location of the point intersection, by removing the 0ₜₕ to second index points of the second stroke 720 as shown in 705.

In operation 645, the processor 220 may determine whether a point intersection exists in a stroke other than the stroke to be corrected when a point intersection exists in points of intersecting strokes. If all the points of the intersecting strokes include a point intersection, the processor 220 may proceed to operation 660 to perform correction by removing the overstretched points after the point intersection.

For example, as illustrated in FIG. 7B, when the point at which the first stroke 710 and the second stroke 720 in 708 intersect is enlarged, the trajectory of 707 may be shown. As illustrated in 708, assuming that the first stroke 710 includes the 24th, 25th, and 26th index points and the second stroke 720 includes the 0th to 7th index points, it may be identified that the location of the intersection point is where the 25ₜₕ index point of the first stroke 710 and the 4ₜₕ index point of the second stroke 720 intersect. As illustrated in 709, the processor 220 may identify that the 0ₜₕ to 3_{rd} index points of the second stroke 720 have been removed and corrected for correction of the second stroke 720.

In operation 655, when a point intersection exists in a stroke other than the stroke to be corrected, the processor 220 may increase the trajectory of a stroke not connected to the point intersection, or update the point location, so that the trajectory is connected to the point intersection. The processor 220 may proceed to operation 660 to perform correction by removing the overstretched points after the point intersection.

For example, when the 25ₜₕ index point of the first stroke 710 is present but the 4ₜₕ index point does not exist in the second stroke 720, a new point index may be generated at the location of the 25ₜₕ index point of the first stroke 710 or the coordinate information of an existing index point may be changed to increase the trajectory of the second stroke 720.

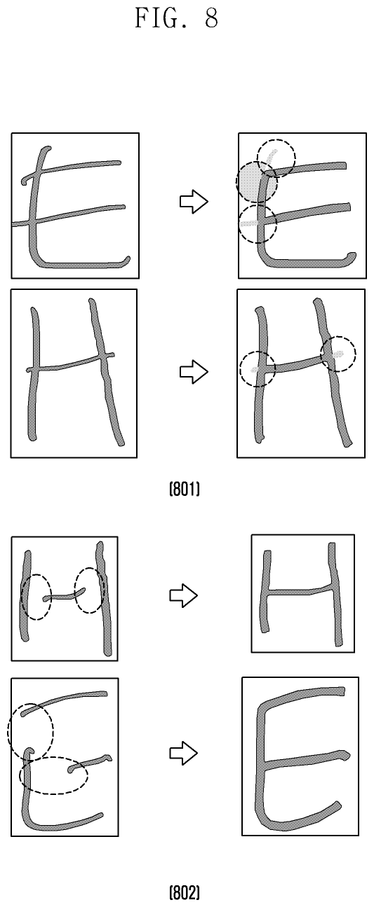

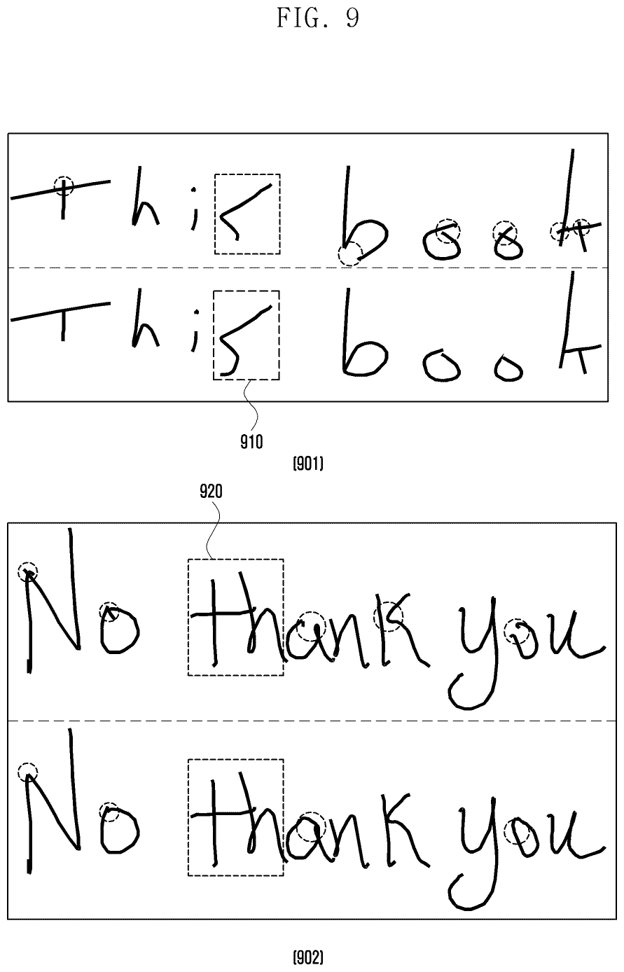

FIGS. 8 and 9 illustrate a comparison between handwriting input data of an electronic device before and after correction according to an embodiment.

Referring to FIGS. 8 and 9, the electronic device 101 may correct the user's handwriting input for each phoneme character and identify, as part of this operation, a portion in which trajectories of strokes constituting the phoneme character “E” intersect, as shown in 801, and delete trajectories of overstretched strokes in the intersecting portion. Independently therefrom, the electronic device 101 may identify a portion in which trajectories of strokes constituting the phoneme character “H” intersect and delete trajectories of overstretched strokes in the intersecting portion. part.

Conversely, as part of a correction operation for handwriting input of the electronic device 101, as shown in 802, the electronic device 101 may increase touch trajectories up to a point where strokes intersect when there is no portion where trajectories of strokes that constitute the phoneme character “H” intersect. Independently therefrom, the electronic device 101 may also increase touch trajectories up to a point where strokes intersect for the phoneme character “E.”

According to various embodiments, the electronic device may recognize a user's handwriting input on a per-phoneme-character basis and perform correction for each phoneme character, thereby selectively correcting only the phoneme character units that require correction among the user's handwriting input.

For example, FIG. 9 may be an example screen that visualizes handwriting input entered by a user and an example screen that visualizes handwriting input after correction according to the disclosed operation. As shown in 901 of FIG. 9, the user may handwrite “This book” on the touchscreen display. The electronic device may recognize “This book” on a per-phoneme-character basis—capital letter “T,” small letter “h,” small letter “i,” small letter “b,” small letter “o,” small letter “o,” and small letter “k”—and may select the capital letter “T,” the small letter “b,” the small letter “o,” the small letter “o,” and the small letter “k” as target characters for correction and perform correction based on intersection characteristics of strokes that constitute each phoneme character.

Likewise, in 902 of FIG. 9, the electronic device 101 may recognize the user's handwriting input for “No, thank you” on a per-phoneme-character basis—capital letter “N,” small letter “o,” small letter “a,” small letter “n,” small letter “k,” small letter “y,” small letter “o,” small letter “u”13 and may select the capital letter “N,” the small letter “o,” the small letter “a,” the small letter “k,” and the small letter “o” as target characters for correction and perform correction based on intersection characteristics of the strokes.

In this case, “s” 910 of 901 or “th” 920 of 902 may be excluded from the target characters for correction because recognition on a per-phoneme-character basis by the electronic device has failed, or it is determined that the recognition code of “s,” or the recognition codes of “t” and “h,” do not meet defined reference features.

As described above, various embodiments may provide a user with more neatly organized handwriting while maintaining the user's handwriting characteristics as compared to the user's original handwriting input.

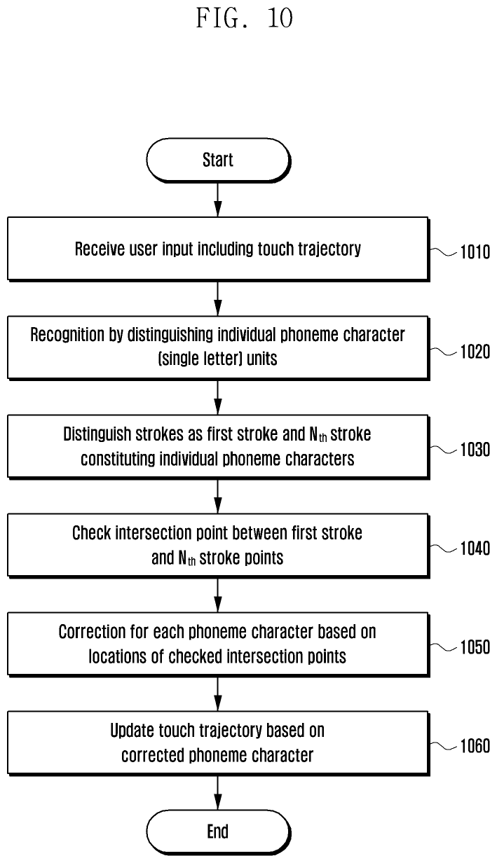

FIG. 10 illustrates a method for correcting handwriting input data of an electronic device according to an embodiment.

Referring to FIG. 10, in operation 1010, the processor (e.g., the processor 120 in FIG. 1 or the processor 220 in FIG. 2) of the electronic device 101 according to an embodiment may receive a user input (e.g., touch data) including a touch trajectory from a touchscreen display. For example, the processor 220 may receive a user input (e.g., touch data including a touch trajectory) based on a proximity and/or touch signal from the touchscreen display 210.

In operation 1020, the processor 220 may recognize handwriting input data by distinguishing individual phoneme-character (single-letter) units, based on the user input.

According to an embodiment, the processor 220 may recognize handwriting input by dividing it into individual phoneme characters (single letters) through the handwriting recognition engine 221. For example, the processor 220 may group strokes according to a touch trajectory included in the user input (e.g., touch data) on a per-phoneme-character basis (single letters) and recognize a phoneme character composed of the grouped strokes. For example, the processor 220 may group a first stroke (e.g., a vertical stroke) and a second stroke (e.g., a horizontal stroke) when the first and second strokes constitute one character (e.g., the capital letter T), and recognize the grouped strokes as one phoneme character (e.g., the capital letter T).

In operation 1030, the processor 220 may distinguish between a first stroke and one or more Nₜₕ strokes that constitute phoneme characters for each phoneme character included in the recognized handwriting input data.

According to an embodiment, the processor 220 may distinguish strokes that constitute phoneme characters based on stroke data (handwriting input data, cursive data, and touch-drawing data) of the recognized phoneme character (e.g., English, numbers, Korean, symbols)., etc.).

According to an embodiment, the stroke data may include a recognition code (e.g., T) for identifying a phoneme character and stroke information (e.g., stroke information constituting the phoneme character “T”). The stroke information may include at least one of the number of strokes grouped by one phoneme character, the order of strokes (e.g., the order of the first stroke and the second stroke), points of the strokes (e.g., index information of points included in the first stroke and index information of points included in the second stroke), stroke width or touch pressure (e.g., stroke thickness or size of a touch region), location of the stroke, length of the stroke, slope of the stroke, direction of the stroke, and the distance between strokes.

According to an embodiment, the processor 220 may extract stroke features that constitute individual phoneme characters.

In operation 1040, the processor 220 may determine whether a point intersection exists between points of a first stroke and the one or more Nₜₕ strokes constituting the phoneme character for each phoneme character. To determine whether a point intersection exists between points of the first stroke and the one or more Nₜₕ strokes, the processor 220 may use a counterclockwise (CCW) algorithm, determine whether a portion of an extension of points included in the trajectory of the first stroke is included in a portion of the trajectory of the second stroke, or determine whether a point intersection exists between points constituting the first stroke and the second stroke.

In operation 1050, the processor 220 may correct phoneme characters for each phoneme character according to the location of the point intersection.

According to an embodiment, when trajectories between strokes intersect each other, the processor 220 may remove an overstretched trajectory from among the touch trajectories, or when trajectories between strokes do not intersect each other in the phoneme character, the processor 220 may increase the touch trajectory so that one stroke is connected to another stroke.

According to an embodiment, the processor 220 may generate a point intersection between two strokes when there is no point intersection where trajectories intersect between points corresponding to touch trajectories of the first stroke and the one or more Nₜₕ strokes, and increase the touch trajectory so that the first stroke or the one or more Nₜₕ strokes is connected to the generated point intersection.

The processor 220 may determine whether a point intersection exists between the start and end points of a stroke when the phoneme character is recognized as a phoneme character composed of one stroke, remove points of an overstretched trajectory when the point intersection between the start and end points is overstretched, and increase the touch trajectory so that a point intersection occurs when the start and end points do not intersect.

In operation 1060, the processor 220 may update a touch trajectory corresponding to the handwriting input data based on the corrected phoneme character.

According to an embodiment, the processor 220 may update the handwriting input data (e.g., stroke data), such as by updating the touch trajectory, based on the correction result for each phoneme character and output the updated handwriting input on the touchscreen display.

A method for correcting handwriting input data performed by an electronic device 101 according to an embodiment may include receiving a user input including a touch trajectory from the touchscreen display 210.

The method according to an embodiment may include recognizing handwriting input data on a per-phoneme-character basis based on the user input.

The method according to an embodiment may include distinguishing a first stroke and one or more Nₜₕ strokes constituting a phoneme character for each phoneme character included in the recognized handwriting input data.

The method according to an embodiment may include determining whether a point intersection exists between points of the first stroke and the one or more Nₜₕ strokes for each phoneme character.

The method according to an embodiment may include correcting each phoneme character based on the location of the determined point intersection. The method according to an embodiment may include updating a touch trajectory corresponding to the handwriting input data based on the corrected phoneme character.

The operation of distinguishing a first stroke and the one or more Nₜₕ strokes constituting the phoneme character for each phoneme character according to an embodiment may be characterized by identifying a recognition code for each phoneme character, extracting a stroke feature constituting each phoneme character, comparing the reference feature defined in the recognition code corresponding to each phoneme character with the stroke feature of the recognized phoneme character to select a phoneme character to be corrected from among handwriting-recognized user inputs, and distinguishing between the first stroke and the one or more Nₜₕ strokes for the selected phoneme character.

The operation of recognizing handwriting corresponding to the user input according to an embodiment on a per-phoneme-character basis may further include outputting stroke data for each phoneme character as a result of the recognition.

The operation of correcting each phoneme character based on the location of the determined point intersections may be characterized by determining whether the trajectories of the first stroke and the Nₜₕ stroke constituting the phoneme character intersect each other, removing an overstretched trajectory based on points of the first stroke and the Nₜₕ stroke when there is a point intersection in point trajectories of the first stroke and the Nₜₕ stroke, and increasing the touch trajectory of either the first stroke or the Nₜₕ stroke so that a point intersection occurs when there is no point intersection between touch points of the first stroke and the Nₜₕ stroke.

The operation of increasing the touch trajectory of the first stroke or the Nₜₕ stroke so that a point intersection occurs when there is no point intersection between touch points of the first stroke and the Nₜₕ stroke according to an embodiment may be characterized by generating a point intersection between two strokes when there is no point intersection where trajectories intersect between points corresponding to touch trajectories of the first stroke and the Nₜₕ stroke, and increasing the touch trajectory so that the first stroke or the Nₜₕ stroke is connected to the generated point intersection.

The operation of correcting each phoneme character based on the location of the determined point intersections according to an embodiment may be characterized by determining whether a point intersection exists between the start and end points of one stroke when the phoneme character is recognized as a phoneme character composed of one stroke, removing points of an overstretched trajectory when the point intersection between the start and end points is overstretched, and increasing the touch trajectory so that a point intersection occurs when the start and end points do not intersect.

The operation of comparing the reference feature defined in the recognition code corresponding to each phoneme character with the stroke feature of the recognized phoneme character to select a phoneme character to be corrected from among handwriting-recognized user inputs according to an embodiment may be configured not to perform correction for the recognized phoneme character when the stroke feature of the phoneme character recognized based on the user input does not meet the reference feature defined in the recognition code of the corresponding phoneme character.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Embodiments as set forth herein may be implemented as software (e.g., the program 140) including one or more instructions that are stored in a storage medium (e.g., the internal memory 136 or external memory 138) that is readable by a machine (e.g., the electronic device 101).

For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include codes generated by a compiler or code executable by an interpreter.

The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

1. An electronic device comprising:
a touchscreen display;
a memory configured to store executable instructions; and
a processor configured to access the memory to execute the instructions,
wherein the instructions, when executed by the processor, cause the electronic device to:
receive a user input including a touch trajectory from the touchscreen display;
based on the user input, recognize handwriting input data on a per-phoneme-character basis;
for each phoneme character corresponding to the recognized handwriting input data, distinguish between a first stroke and one or more Nth strokes constituting the phoneme character;
determine whether point intersections exist between the first stroke and the one or more Nₜₕ strokes for each of the phoneme characters and, when present, determine locations;
based on the locations of the determined point intersections, correct each of the phoneme characters; and
based on the corrected phoneme characters, update the touch trajectory corresponding to the handwriting input data.

2. The electronic device of claim 1, wherein the touch trajectory includes coordinate data of points corresponding to consecutive touches.

3. The electronic device of claim 1, wherein the instructions cause the electronic device to: when recognizing handwriting input data on a per-phoneme-character basis from the user input, output a recognition code and stroke data for each phoneme character as a result of the recognition; and
wherein the stroke data includes at least one of a recognition code for identifying a phoneme character; the number of strokes; order of strokes; index information of stroke points; stroke thicknesses; stroke locations; stroke lengths; stroke slopes; stroke directions; and distances between strokes.

4. The electronic device of claim 3, wherein the instructions cause the electronic device to: when distinguishing between a first stroke and the one or more Nₜₕ strokes constituting a phoneme character:
identify a recognition code for each phoneme character;
extract a stroke feature constituting each phoneme character;
compare a reference feature defined by the recognition code corresponding to each phoneme character with the stroke feature of the recognized phoneme character to select a phoneme character to be corrected from the handwriting-recognized user input; and
selectively distinguish between the first stroke and the one or more Nₜₕ strokes only for the selected phoneme character.

5. The electronic device of claim 4, wherein the instructions cause the electronic device to: when extracting a stroke feature constituting each phoneme character:
extract angular components of points included in each stroke;
convert the extracted angular components into direction vectors;
convert the angular components of the points into eight-direction vectors;
convert the eight-direction vectors into stroke scores to identify each stroke type; and
wherein the stroke type comprises one of a horizontal stroke type; a vertical stroke type; or other stroke types.

6. The electronic device of claim 1, wherein the instructions cause the electronic device to: when correcting each phoneme character, based on the locations of the determined point intersections, if any:
determine whether touch trajectories of the first stroke and the one or more Nₜₕ strokes constituting the phoneme character intersect each other;
in response to determining that there is a point intersection between the touch trajectories of the first stroke and the one or more Nₜₕ strokes, remove portions of the touch trajectory that extend beyond the point intersection, based on the points of the first stroke and the one or more Nₜₕ strokes; and
in response to determining that there is no point intersection between the touch trajectories of the first stroke and the one or more Nₜₕ strokes, increase the touch trajectory of the first stroke or the one or more Nₜₕ strokes such that a point intersection occurs.

7. The electronic device of claim 6, wherein the instructions cause the electronic device to: when there is no point intersection between the touch trajectories of the first stroke and the one or more Nₜₕ strokes: in response thereto, generate a point intersection between two strokes; and
increase the touch trajectory such that the first stroke or the one or more Nₜₕ strokes is connected to the generated point intersection.

8. The electronic device of claim 6, wherein the instructions cause the electronic device to: when correcting each phoneme character, based on the locations of the determined point intersections, if any:
in response to determining that the phoneme character is recognized as being composed of a single stroke, check a point intersection between the start and end points of the single stroke;
in response to determining that the stroke extends beyond the point intersection between the start and end points, remove the points of the stroke that extend beyond the point intersection; and in response to determining that there is no point intersection between the start and end points, increase the touch trajectory such that a point intersection occurs.

9. The electronic device of claim 4, wherein the instructions cause the electronic device not to perform correction for the recognized phoneme character when the stroke feature of the phoneme character recognized based on the user input does not meet the reference feature defined by the recognition code of the corresponding phoneme character.

10. The electronic device of claim 6, wherein the instructions cause the electronic device to: when determining whether the touch trajectories of the first stroke and the one or more Nₜₕ strokes constituting the phoneme character intersect each other, use a counterclockwise (CCW) algorithm, check whether there is a point intersection between points of the first stroke and the one or more Nₜₕ strokes, or check whether some of the points included in the trajectory of the first stroke are included in some of the points included in the trajectory of the Nₜₕ stroke.

11. A method for correcting handwriting input data by an electronic device, the method comprising:
receiving a user input including a touch trajectory from a touchscreen display;
based on the user input, recognizing handwriting input data on a per-phoneme-character basis;
for each phoneme character corresponding to the recognized handwriting input data, distinguishing between a first stroke and one or more Nₜₕ strokes, where N is an integer greater than 1, constituting the phoneme character;
determining, whether point intersections exist between the first stroke and the one or more Nₜₕ strokes for each of the phoneme characters and, when present, determining locations thereof;
based on the locations of the determined point intersections, if any, correcting each of the phoneme characters; and
based on the corrected phoneme characters, updating the touch trajectory corresponding to the handwriting input data.

12. The method of claim 11, wherein distinguishing between the first stroke and the one or more Nₜₕ strokes constituting the phoneme character comprises:
identifying a recognition code for each phoneme character;
extracting a stroke feature constituting each phoneme character;
comparing a reference feature defined by the recognition code corresponding to each phoneme character with the stroke feature of the recognized phoneme character to select a phoneme character to be corrected from the handwriting-recognized user input; and
selectively distinguishing between the first stroke and the one or more Nₜₕ strokes only for the selected phoneme character.

13. The method of claim 11, wherein recognizing the handwriting input data on a per-phoneme-character basis from the user input further comprises: outputting stroke data for each phoneme character as a result of the recognition; and
wherein the stroke data includes at least one of a recognition code for identifying a phoneme character; the number of strokes; order of strokes; index information of stroke points; stroke thicknesses; stroke locations; stroke lengths; stroke slopes; stroke directions; and distances between strokes.

14. The method of claim 11, wherein correcting each phoneme character, based on the locations of the determined point intersections, if any, comprises:
determining whether the touch trajectories of the first stroke and the one or more Nₜₕ strokes constituting the phoneme character intersect each other;
in response to determining that there is a point intersection between the touch trajectories of the first stroke and the one or more Nₜₕ strokes, removing portions of the touch trajectory that extend beyond the point intersection, based on the points of the first stroke and the one or more Nₜₕ strokes; and
in response to determining that there is no point intersection between the touch trajectories of the first stroke and the one or more Nₜₕ strokes, increasing the touch trajectory of the first stroke or the one or more Nₜₕ strokes such that a point intersection occurs.

15. The method of claim 14, wherein, when there is no point intersection between the touch trajectories of the first stroke and the one or more Nₜₕ strokes: in response thereto, generating a point intersection between two strokes; and
increasing the touch trajectory such that the first stroke or the one or more Nₜₕ strokes is connected to the generated point intersection.

16. The method of claim 11, wherein correcting each phoneme character based on the locations of the determined point intersections, if any, comprises:
in response to determining that the phoneme character is recognized as being composed of a single stroke, checking a point intersection between start and end points of the single stroke;
in response to determining that the stroke extends beyond the point intersection between the start and end points, removing points of the stroke that extend beyond the point intersection; and
in response to determining that no point intersection exists between the start and end points, increasing the touch trajectory such that a point intersection occurs.

17. The method of claim 12, wherein selecting a phoneme character to be corrected comprises:
determining that a stroke feature of a phoneme character recognized based on the user input does not meet a reference feature defined by a recognition code corresponding to the phoneme character; and
in response thereto, not performing correction for the recognized phoneme character.

18. An electronic device comprising:
a touchscreen display;
a memory configured to store executable instructions; and
a processor configured to access the memory to execute the instructions, wherein the instructions, when executed by the processor, cause the electronic device to:
receive a user input including a touch trajectory from the touchscreen display;
based on the user input, recognize handwriting input data on a per-phoneme-character basis;
for each recognized phoneme character, extract stroke features by converting angular components of points included in each stroke into direction vectors, converting the direction vectors into eight-direction vectors, and converting the eight-direction vectors into stroke scores;
identify, for each recognized phoneme character, a reference feature defined by a recognition code associated with the phoneme character, and select a subset of the recognized phoneme characters for correction based on whether the stroke features meet the corresponding reference feature;
for each selected phoneme character, determine whether the phoneme character is circle-type;
for a selected circle-type phoneme character, determine whether a point intersection exists between start and end points of a stroke, and when the point intersection does not exist, generate a point intersection and increase the touch trajectory so that the stroke is connected to the generated point intersection, and when the point intersection exists and the trajectory extends beyond the point intersection, remove points of the stroke that extend beyond the point intersection;
for a selected non-circle-type phoneme character, distinguish between a first stroke and one or more Nth strokes constituting the phoneme character, where N is an integer greater than 1, determine whether a point intersection exists between the first stroke and the one or more Nth strokes, and when the point intersection does not exist, generate a point intersection and increase a trajectory of the first stroke or the one or more Nth strokes so that the stroke is connected to the generated point intersection, and when the point intersection exists and a trajectory extends beyond the point intersection, remove points of the trajectory that extend beyond the point intersection;
update index information of one or more stroke points to correspond to a location of a generated or determined point intersection; and
based on the updated index information, update the touch trajectory corresponding to the handwriting input data and render corrected handwriting on the touchscreen display.
